(19) United States
(12) Patent Application Publication
(10) Pub. No.: US 2002/0161693 A1
(43) Pub. Date: Oct. 31, 2002

(54) Automated over-the-counter derivatives trading system

(76) Inventor: Jamie A. Greenwald, Greenwich, CT (US)

Correspondence Address: Joseph Levi, Esq., Clifford Chance Rogers & Wells LLP, 200 Park Avenue, New York, NY, 10016, US

(21) Appl. No.: 09/845,900

(22) Filed: Apr. 30, 2001

(51) Int. Cl. G06F 17/60

(52) U.S. Cl. 705/37; 705/26

(57) ABSTRACT

A system operated by a financial institution for facilitating a trade in a non-listed security is provided and include a past trades database for storing trade information regarding past trades executed through the system. Also included is pricing engine for providing price quotes in the non-listed security to client, the pricing engine being in communication with the past trades database receiving as input financial information. When the client requests a price quote for the non-listed security, the pricing engine provides the price quote based on the financial information and the past trades in the past database.

### BACKGROUND

The following invention relates to over-the-counter (OTC) derivatives and, in particular, to a method and system for facilitating transactions in non-listed OTC derivatives between a client and a professional counterparty.

Numerous exchanges exist for buying/selling virtually any type of security, including stocks, bonds and derivative products. Many securities are traded through interaction with an intermediary associated with a public exchange. For example, for stocks listed on the New York Stock Exchange (“NYSE”), the intermediary is a specialist on the floor of the NYSE that establishes a market in a particular stock by setting the highest price at which the specialist will buy the stock (“bid price”) and the lowest price at which the specialist will sell the stock (“offer price”). The specialist then engages in transactions with buyers/sellers of the stock thereby creating a liquid market in the stock. Typically, exchanges that deal in listed securities, such as the NYSE, have systems and procedures in place for disseminating the bid/offer price established by the specialist, for receiving orders to buy/sell a particular security, for executing an order to buy/sell a security and for reporting all transactions in a security.

Aside from exchange-listed securities (defined as the standardized and regulated products publicly traded on major exchanges (for example, CBOE—Chicago Board of Option Exchange)), there are tradeable securities that are not listed on an exchange. For example, while an option to buy IBM stock at a strike price of 135 expiring in September is listed on the CBOE, an option to buy IBM stock at a strike price of 133 expiring in August is not listed on the CBOE. An investor desiring to purchase such non-listed IBM 133 calls will have to turn to the OTC derivative markets to find a counter-party willing to sell to the investor IBM 133 calls. These markets are typically formed by large financial institutions that engage in creating OTC derivatives as a customized service to their clients.

Unlike the trading of exchange-listed securities, the process by which non-listed derivatives are traded is far from automated. Typically, the process starts by an investor calling a salesperson at an institution with which the investor has a relationship and asking for a price quote on a particular non-listed security, for example IBM 133 calls with an expiration date of X and a size of Y. The salesperson records the request for quote and manually brings it to a trader responsible for that class of underlying equity securities. In order to establish a price for the IBM 133 calls, the trader often performs extensive research including investigation of the price, volume, volatility and history of the underlying IBM stock as well as previous price quotes for the non-listed security. The trader then applies financial analytics to this data to forecast price trends and examines the pricing structure of listed IBM options. In addition, the trader typically looks at the trader's own portfolio of IBM stock, listed and non-listed IBM options to determine the trader's risk associated with selling IBM 133 calls to the investor, and to determine the trader's ability to hedge the position. Based on this information and analysis, the trader determines a price for the IBM 133 calls and forwards the price quote to the salesperson. The salesperson in turn contacts the investor to provide the investor with the desired indicative price quote.

Because the process of responding to a price quote request for a non-listed derivative is slow and time-consuming, and the market fundamentals affecting the price quote often change rapidly, the price quote received by the investor is often “stale” (i.e. indicative) and cannot be used as a basis for “dealing” in the non-listed security. Thus, if the investor wants a “dealing” price quote, the salesperson typically goes back to the trader who updates the original price quote based on the previous research done by the trader and any subsequent changes in market fundamentals.

Before the investor is cleared to trade at the dealing price quote, the salesperson typically makes several phone calls within the financial institution to check that the investor is able to transact with the financial institution in the OTC derivative. Such pre-trade checks typically include credit approval, documentation status and determining whether the OTC derivative is based on an underlying stock that is on the financial institution's restricted list (indicating, for example, an advisory assignment or position limits) in which case the financial institution cannot act as a counterparty to the transaction.

In order to execute a trade in the non-listed derivative after receiving a dealing price quote, the investor informs the salesperson of the investor's desire to complete the transaction. The salesperson logs the investor's trade, which is typically contingent on the trader's ability to hedge the resulting position, and then forwards the trade to the trader. Once the trader executes a hedge for the position, the investor is provided with a notification confirming the trade.

The prior art process through which investors trade in non-listed derivatives is severely flawed. First, the prior art process does not efficiently provide an investor with current price quotes upon which the investor can base a trade. Because the investor's price request is passed from the salesperson to the trader and then back, and because a price quote becomes stale quickly (often within 5 minutes of being rendered by the trader), the investor may have to request a price quote several times in order to get a “dealing” price quote. The delay in rendering a price quote is further exacerbated by the trader's need to perform time-consuming research and check several sources of information that forms a basis for the price quote. Furthermore, the trader will typically examine any previously quoted prices for the particular non-listed security before rendering a new price quote. The prior art process, however, does not log these previous price quotes and provide this information to the trader. Thus, the trader must search for this previous pricing information manually, which will further delay the rendering of a price quote. This paradigm makes matters very complicated and inefficient if an investor asks different financial institutions for competing bids/offers for the OTC derivative. In such cases, it may take the investor days to complete a transaction depending on its complexity.

Another drawback of the prior art process for trading non-listed securities is the uncertainty inherent in the order entry and execution process. Even after the investor places an order to purchase a particular unlisted security, the terms of the investor's trade are not confirmed until the trader is notified of the purchase order and has executed a hedge against the resulting position. In the interim, the investor's position with respect to the particular non-listed security is uncertain which may put the investor at a significant disadvantage in a fast moving market.

A significant drawback in the prior art process exists with respect to post-trade order handling and booking. Post-trade procedures also include updating credit exposure systems, collateral systems, the books and records of the financial institution and divisional risk management systems. Post-trade procedures further include providing daily valuations to clients, settling premiums and reconciling the books and the records of the firm (i.e., matching terms provided manually by salespersons to the terms entered for risk purposes by traders). Because order entry and execution is a manual process that involves the salesperson and the trader, information describing the executed order is typically not centrally stored, but rather is distributed between the salesperson and the trader. Traditionally, no database exists to collect all relevant transaction data for client service needs, trader and salesperson needs, and management information purposes. Consequently, it is difficult to retrieve complete and accurate information regarding prior transactions by a client or from the firm's perspective. The difficulty in collecting reliable transaction information and the lack of a centrally stored transaction file results in numerous inefficiencies in the prior art process. First, the process of recording the transaction on the institution's books is time-consuming and error-prone. Also, without a transaction file that includes all the prior trades in a particular security and all the trades of a particular investor, the process of gauging the risk to the institution associated with a particular trade and establishing appropriate collateral requirements is inefficient and cumbersome. Post execution procedures include updating credit exposure systems, collateral systems, firm books and records, divisional risk management systems, providing daily valuations to clients, setting premiums, and more. All or most of these procedures are entirely manual. In addition, the process of creating a trade confirmation document and ensuring that the investor accepts the terms contained therein (recognized by a manually signed and faxed confirmation from the client) is time consuming, taking on average one week to a month to complete. Furthermore, the prior art system does not provide a salesperson, or the investor, with easy access to previously executed trades. In particular, the prior art process does not provide the investor with the capability of viewing the investor's open positions, calculating each position's value and managing collateral requirements. In summary, the method of providing post-trade services in the prior art process is manually intensive, inefficient and error prone.

Accordingly, it is desirable to provide a system and method for facilitating trades of non-listed securities as well as the post-trade management of such trades.

### SUMMARY OF THE INVENTION

The present invention is directed to overcoming the drawbacks of the prior art and reinventing the way clients can use and benefit from the business. Under the present invention a system operated by a financial institution for facilitating a trade in a non-listed derivative security is provided and includes a past trades database for storing trade information regarding past trades executed through the system. Also included is a pricing engine for providing price quotes in the non-listed security to a client, the pricing engine being in communication with the past trades database and receiving market financial information as input. When the client requests a price quote for the non-listed derivative security, the pricing engine provides the price quote in less than a second based on the past trades in the past trade database and the necessary market information.

In an exemplary embodiment, the financial information includes interest rate information, dividend information relating to the non-listed security, tax credit information, borrowing cost information, volatility information (historical and implied), correlations, volumes and data on similar contracts trading in the market globally.

In another exemplary embodiment, a price log for storing said price quotes in the non-listed security is provided and the pricing engine provides the price quote based on the past quotes stored in the price log and all current market information obtained from a data source.

In yet another exemplary embodiment, the pricing engine continuously updates for a client the price quotes, both bid and offer, in real time or near real time. In contrast, the prior art systems do not embody a two way bid/offer market in OTC derivatives, or any real time quoting mechanism.

In an exemplary embodiment of the present invention, an electronic check ability to trade (CATT) module is provided. When the client desires to transact in the non-listed security, the CATT module determines the client's ability to trade based on the client's credit status, documentation status, collateral status, and premium settlement status, etc.

In another embodiment of the present invention, a hedging module for performing hedging transactions is provided and when the client requests a trade in the non-listed security based on the price quote, the hedging module executes a hedging transaction for hedging the trade. Also, the information regarding the trade is stored in the past trades database. There is no longer a necessary reliance on a trader's ability to hedge a transaction. When a client accepts a transaction, it is completed with all terms and sizes pre-specified.

The system of the present invention includes electronic connections to a client, relying either on the Internet or any other suitable connection between the firm and client. The system relies on an automated derivative market making function to provide immediate dealing prices for electronic client requests, with an acceptance of the price by a client being an acceptance of an electronically created trade confirmation (optional), all in real time. The positions requested and traded by the client will all be seen directly from the firm database, and all positions will have prices, bid and offer, continuously updated through the day (at client's option). The present invention provides transparency and real time market quoting—benefits not found in the conventional OTC derivative business.

In another exemplary embodiment, a trade confirmation generator in communication with the past trade database is provided, and when the trade is stored in the past trades database, the trade confirmation generator generates a trade confirmation based on the trade information and the trade confirmation is provided to the client immediately. The trade confirmation may be provided to the client through any means including, for example, by electronic means.

In yet another exemplary embodiment, a booking module in communication with the past trades database for determining a net position for each non-listed security in the past trades database is provided wherein the booking module forwards the net position to the financial institution's books, records, and risk management systems. In addition, the booking module identifies those of the trades in the past trades database that require special handling and processes the trades accordingly.

In an exemplary embodiment, a sales credit module is in communication with the past trades database for calculating a performance measure of the trades. The performance measure calculated may be the profits earned by the financial institution per each client, per each transaction and/or per each sales representative of the financial institution, as well as any other suitable performance measure.

In another exemplary embodiment, a client portfolio analyzer is in communication with the past trades database for providing the client with viewing access of the trades performed by the client. The client portfolio analyzer is enabled to view and/or stress test the trades by aggregating at least some of the trades performed by the client by security type and/or by strategy. The analytical tools to analyze portfolio performance and risks are incorporated. Further, the clients, in effect, can instantly obtain a two-way market on a security that either exists in their current portfolios or on one that does not yet exist, whether they want to trade or simply analyze or monitor it.

Accordingly, a system and method is provided in which clients of financial institutions are provided with real-time, dealing quotes for OTC derivatives upon which the client may transact in the security and receive confirmation of the transaction immediately. The client can also instantly obtain a two-way market on an OTC derivative whether the client desires to transact in, or simply monitor, the particular OTC derivative. The system also provides the client with automated access to the client's trading activity for viewing analyzing and updating the client's portfolio. The risk and time delay associated with providing clients with dealing quotes and trade executions is mitigated through automatically checking the client's ability to trade before issuing a price quote, and (as desired by the client) by automatically hedging each trade request thereby eliminating any execution risks to the client.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is a block diagram of the OTC trading system of the present invention;

FIG. 2, is a block diagram of an OTC trading system according to an alternative embodiment of the present invention; and

FIG. 3 is an expanded block diagram view of the post-trade management module of FIGS. 1 and 2.

### DETAILED DESCRIPTION OF THE PREFERRED EMBODIMENTS

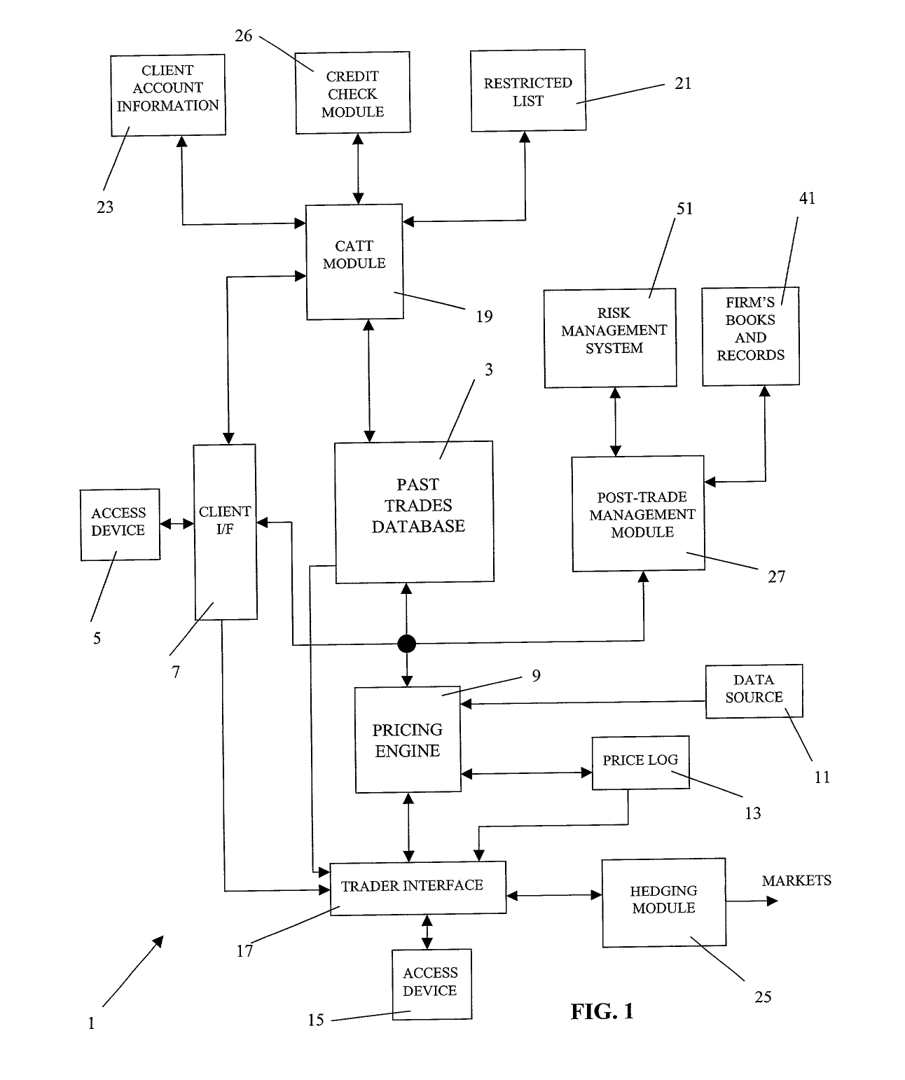

Referring now to FIG. 1, there is shown a block diagram of the OTC trading system 1 of the present invention. Whenever a client desires to transact in an OTC derivative product, system 1 enables such a client to receive timely, dealing quotes for the particular OTC derivative product, execute a trade in the OTC derivative product and monitor the client's portfolio of OTC derivative products. In addition, system 1 enables a financial institution to manage all aspects of the OTC trading environment including transaction hedging, trade confirmation documentation, risk management, trade booking and performance monitoring. System 1 may be used by any entity, for example, a financial institution that desires to provide its clients with a market in which to trade OTC derivatives.

System 1 includes a past trades database 3 that stores all OTC trade activity engaged in by system 1. Past trades database 3 stores all pertinent information regarding an OTC transaction including, by way of non-limiting example, the client name, client account number, transaction type and size, notional amount, strike price, expiration date, underlying price, dividends, volatility at the time of the trade, valuation date and method as well as any other relevant information. As will be described in detail below, the use of past trades database 3 in system 1 provides numerous advantages that overcome the deficiencies of prior art OTC derivatives business practices.

A client accesses system 1 by operating an access device 5 that is, by way of non-limiting example, a personal computer, terminal or wireless handheld device operating software that provides a communications link to system 1 using well-known techniques. Access device 5 may communicate with system 1 using any communications method, protocol and/or medium including, but not limited to, the Internet, dial-up lines, token-ring and/or Ethernet networks, T1 lines, asynchronous transfer mode links, wireless links, digital subscriber lines (DSL) and integrated service digital network (ISDN) connections. Upon accessing system 1, access device interfaces with a client interface 7 through which the client makes use of the capabilities and functionality of system 1.

Client interface 7 provides the client with a user interface consisting of a plurality of screenshots for receiving information from, and providing information to, access device 5. For example, upon request from a client, client interface 7 provides access device 5 with a screenshot in which the client may request from system 1 a price for a particular OTC product. Similarly, client interface 7 provides other screenshots to access device 5 through which a client may interact with system 1. The presentation of information to and the receipt of information from the client via the plurality of screenshots may be achieved using well-known user-interface design techniques.

Client interface 7 is in communication with a pricing engine 9 that provides pricing of the particular OTC product requested by the client. In order to generate a price quote in response to a client request, pricing engine 9 receives from a data source 11 various economic and financial data upon which the price quote may be based. For example, pricing engine 9 may receive from data source 11 real-time data regarding interest rates, borrowing costs, dividends, tax credits and any other information useful for determining a price for a particular OTC product. In addition, pricing engine 9 receives from past trades database 3 prices for the particular OTC product that were used in previous trades. Pricing engine 9 also receives from a price log 13 any price quotes that were previously provided by system 1 for the particular OTC product whether or not a trade was executed based on such price quotes. In addition to the economic and financial data and historical pricing data, pricing engine 9 receives the firm's portfolio position information from a risk management system 51 operated by the financial institution that has relevance to the particular OTC product, including portfolio position information regarding the security underlying the particular OTC product. Thus, all the data necessary for pricing the OTC products are aggregated in pricing engine 9. A trader, operating an access device 15, such as a personal computer, terminal or wireless handheld device, receives via client interface 7 and a trader interface 17 a notification that a client desires a price quote for a particular OTC product. Upon receipt of the price request, the trader analyzes all relevant data including, past trade information from past trades database 3, past price quotes from price log 13, and economic and financial data, in order to determine a surface volatility for the security underlying the particular OTC product using known techniques. The trader then communicates the surface volatility to pricing engine 9 via trader interface 17. Pricing engine 9 then uses the surface volatility provided by the trader, as well as the other information aggregated therein, to calculate a price for the particular OTC product. The method of generating a price quote for an OTC product based on surface volatility and the information aggregated by pricing engine 9 is well-known in the art. (See, for example, “The Complete Guide to Option Pricing Formulas” by Espen Haug (McGraw Hill, 1997) (hereinafter “Option Pricing Formulas”), the contents of which are incorporated herein by reference). If the price quote generated by pricing engine 9 is acceptable to the trader, the trader causes the price quote to be communicated by pricing engine 9 to client interface 7 for presentation to the client.

Accordingly, because all the information upon which the trader bases a pricing decision is automatically aggregated and/or calculated by pricing engine 9, the trader can provide a responsive price quote to the client with little delay. Furthermore, because the price quote provided by the trader is based on real-time economic and financial information, the trader may designate the price quote as a dealing quote upon which the client may execute a trade.

In an exemplary embodiment, the trader may periodically provide pricing engine 9 with an updated surface volatility for particular underlying securities reflecting the trader's changing view of the market for those underlying securities. Upon receiving a price request from a client, pricing engine 9 can then calculate a price based on the trader's updated surface volatility and present the calculated price to the trader. After the trader reviews the calculated price and has had the opportunity to update the surface volatility for the particular underlying, as necessary, pricing engine 9 then presents a dealing price quote to the client and the client may make a trade upon this price quote.

In addition to providing pricing engine 9 with surface volatility figures, the trader may impose constraints on any pricing generated by pricing engine 9. For example, the trader may instruct pricing engine 9 to generate pricing only for price requests having associated therewith a particular size range, expiration date or strike price. Similarly, the trader may impose any other constraints on pricing engine 9. For those price requests that fall outside of the constraints imposed by the trader, pricing engine 9 notifies the trader of the particular price request so that the trader may either directly establish a responsive price, as described above, or decline the particular price request.

In either of the two embodiments of pricing engine 9 described above—where the trader provides a surface volatility to pricing engine 9 in response to a price request and where pricing engine 9 automatically generates a price based on the periodically updated surface volatility and constraints provided by the trader—each time the client desires a current price for the particular OTC product the client must issue a new request for price to pricing engine 9. Because prices for OTC products become “stale” quickly, the client may have to repeatedly request updated pricing until a trading decision by the client is made. While the above embodiments greatly reduce the delay in generating a responsive price quote, the client must still actively refresh the price quote by periodically requesting an updated price. Furthermore, in both of the two embodiments, the prices provided to the client are agency prices, i.e. are subject to the trader's ability to hedge the position that will be acquired by the financial institution if it acts as the counter-party to the client trading in the particular OTC product. Thus, even if the client requests a trade based on a price quote provided by pricing engine 9, the client will not know whether the trade was completed until the trader has successfully performed hedging transactions.

In the event the client desires to execute a trade in a particular OTC product based on a dealing price quote received from the trader, the client issues a trade request to client interface 7 for the quoted OTC product. Before a trade in the OTC product on behalf of the client is consummated, client interface 7 issues a ‘clear to trade’ request to a check ability to trade (“CATT”) module 19. In determining the client's ability to trade in the particular OTC product, CATT module 19 checks a number of factors. First, CATT module 19 accesses a restricted list file 21 to determine whether the particular OTC product includes an underlying security in which the financial institution cannot deal, because of, for example, conflict of interest concerns or the institution's ownership stake in the particular underlying. In addition, CATT module 19 checks a client account information file 23 to determine whether the client has the capacity and authority to place the trade and whether the necessary documents governing the client-financial institution relationship such as, by way of non-limiting example, an ISDA master agreement or a collateral agreement, are on file. CATT module 19 also requests a collateral status from credit check module 26 to check the client's collateral balances and determine whether the client has sufficient credit capacity to enter into the proposed transaction. The client's collateral status may depend, in part, on the client's existing OTC positions, that are stored in past trades database 3, as well as other positions the financial institution is holding for the client. In addition to the above checks, CATT module 19 may make any other checks, using techniques well-known in the art, to determine the client's ability to trade in the particular OTC derivative product. If the client is cleared to trade in the particular OTC derivative product, CATT module 19 informs client interface 7 of the client's ability to trade and client interface 7 then forwards the client's trade request to trader interface 17.

Because no ready markets exist for OTC products and the financial institution itself is typically the counter-party for the client's requested transaction, the client's requested transaction is not confirmed until the financial institution has hedged its position that would result from the transaction. Therefore, upon being notified, via trader interface 17, of the client's trade request, the trader hedges the financial institution's position in the particular OTC product that is the subject of the trade using well-known hedging techniques. In an exemplary embodiment, the trader accesses a hedging module 25 that implements the hedge using techniques well-known in the art. Hedging module 25 may comprise a computer program that implements well-known hedging rules, a trader skilled in hedging techniques or a combination of the two. Prior art methods for determining the transactions suitable for hedging a derivative position are disclosed in “Pricing and Hedging Derivatives” by Lars Nielsen (Oxford University Press, 1999), the contents of which are incorporated herein by reference.

Once the financial institution's position is hedged, the client is notified via client interface 7 that the desired trade was executed and past trades database 3 is updated to reflect the transaction in favor of the client. Furthermore, after trade execution, a series of post-trade management tasks are performed by post-trade management module 27, as will be described below.

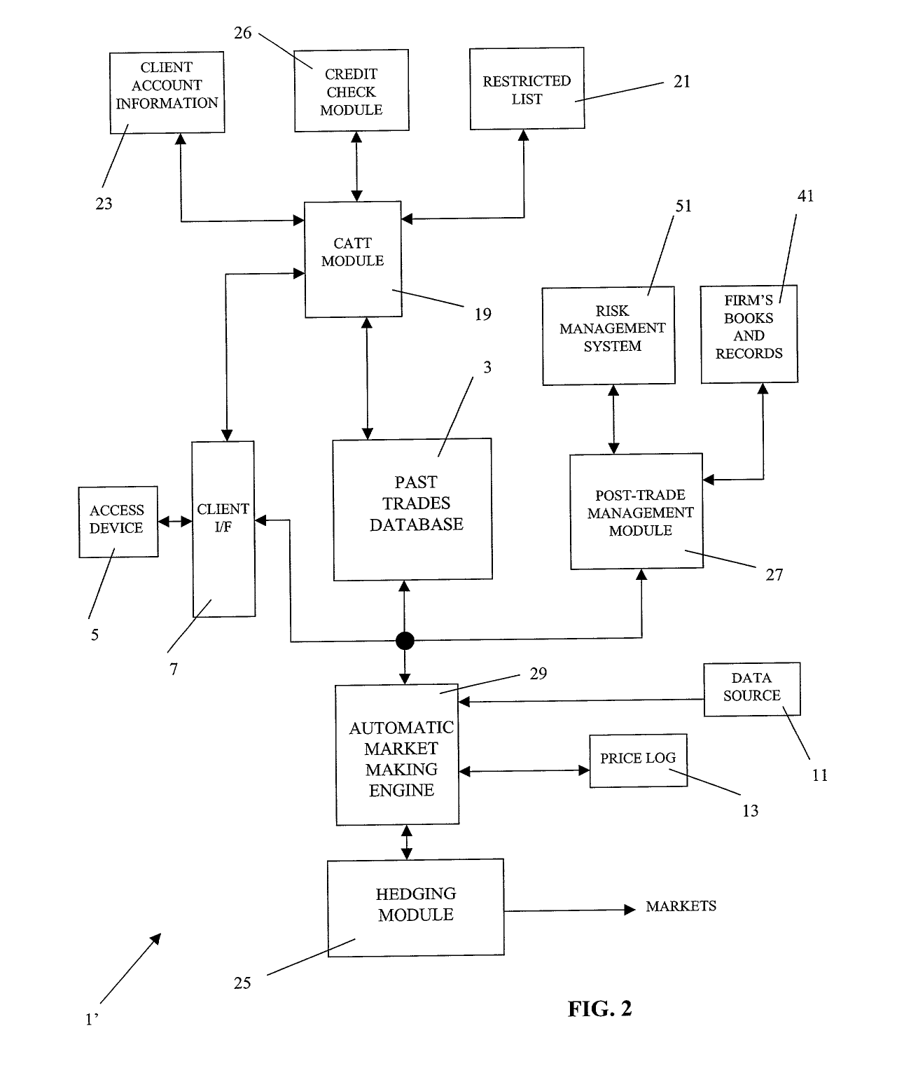

As described above, the embodiment shown in FIG. 1 requires that all dealing price quotes be directly set by the trader and that any trade request issued by a client is not confirmed until the resulting position is hedged by the financial institution. Referring now to FIG. 2, is shown a block diagram of an OTC trading system 1′ according to an alternative embodiment of the present invention in which dealing quotes are provided without trader intervention, client trade requests are executed instantaneously and trade confirmations are generated either instantaneously or on a post-trade basis, as desired by the client. System 1′ also provides the client with continuously updated bid/ask prices for the particular OTC product thereby creating for the client a “virtual market” for the OTC derivative product—a security which is not otherwise traded on any exchange. Elements of the embodiment of FIG. 2 that are similar to elements of the embodiment of FIG. 1 are similarly labeled and a detailed description thereof will not be repeated.

In this embodiment, client interface 7 forwards a price request from the client to an automatic market making (“AMM”) engine 29. In order to provide the client with an automatic dealing quote, AMM engine 29 initially breaks down the OTC derivative product, that is the subject of the price request, into its component risk factors. These risk factors may include, by way of non-limiting example, an equity risk factor that relates to the volatility of the equity underlying the particular OTC derivative, an interest rate risk factor and a currency risk factor. AMM engine 29 then evaluates each of the component risk factors with respect to its contribution to the overall risk position of the financial institution. AMM engine 29 also evaluates various risk factors associated with hedging the particular OTC derivative using, by way of non-limiting example, listed securities, derivatives in the same underlying, and/or derivatives in similar but different underlyings (where correlation methods are used for pricing implications resulting from similar underlyings). These risk factors may include, by way of non-limiting example, the currency risk, interest rate risk and portfolio risk associated with the particular OTC derivative. In addition, AMM engine 29 receives data, of a similar nature as pricing engine 9 of FIG. 1, including the real-time data regarding equity prices, interest rates, borrowing costs, dividends, tax credits from data source 11 as well as past trade prices and price quotes from past trades database 3 and price log 13, respectively. AMM engine 29 also receives real-time data with respect to option prices for similar underlyings, the implied volatilities of such similar underlyings as well as correlations between relevant underlyings. Based on this data, as well as the risk factor analysis, AMM engine 29 automatically calculates dealing bid and offer prices for the particular OTC derivative without any request-specific trader intervention. (Prior art methods for calculating the bid and offer prices for derivatives are disclosed in “Option Pricing Formulas” cited above). AMM engine 29 then instantly forwards the dealing bid and offer prices to the client via client interface 7.

Furthermore, AMM engine 29 continuously (i.e., in short intervals, for example every 5 seconds to 5 minutes or longer) updates the dealing bid and offer prices for the particular OTC product in real-time based on any changes to the parameters relied on by AMM engine 29 as well as changes in supply and demand activity. In this way, the client is provided with streaming real-time quotes for the particular OTC product of interest. Furthermore, because the price quotes received by the client are dealing quotes, the client can base a transaction request on such quotes. Thus, system 1′ provides the client with the ability to create a virtual market in a selected OTC product that includes real-time “market-like” pricing and in which the client receives bid and offer quotes in a manner similar to the bid/offer pricing one would receive for an exchange-listed product. System 1′ also provides the client with the ability to trade on such prices even though no actual market exists for such OTC product.

In addition to providing real-time dealing pricing, AMM engine 29 automatically determines the transactions that are optimally (i.e., least cost, most effective) necessary for the financial institution to hedge a client transaction in the OTC derivative. If the client places an order for the particular OTC derivative product, AMM engine 29 then automatically forwards such optimized hedging transactions to hedging module 25 that then interfaces with the financial markets to execute such hedging transactions. Because the financial institution's risk position as a result of acting as a counterparty in the OTC derivative transaction with the client is automatically hedged at the time of the transaction, the transaction is completed immediately and does not depend on a trader's ability to execute a hedge. As a result, the execution risk associated with the transaction is transferred from the client to the financial institution at the time the order is placed by the client.

For some client trades, hedging transactions may be not necessary due to the existing positions in the financial institution's portfolio. AMM engine 29 thus accesses risk management system 51 to determine whether the financial institution's existing portfolio position is such that hedging transactions are not required to hedge the risk associated with the client transaction.

In an exemplary embodiment, the trader sets rules according to which AMM engine 29 operates. For example, the trader may decide the approved underlyings for which AMM engine 29 may automatically provide a price quote. For transactions involving non-approved underlyings, the trader would then provide a price quote using pricing engine 9 of system 1. In addition to approved underlyings, the trader may set rules relating to other trade parameters including, but not limited to, maximum transaction size, expiration date and maximum risk limits.

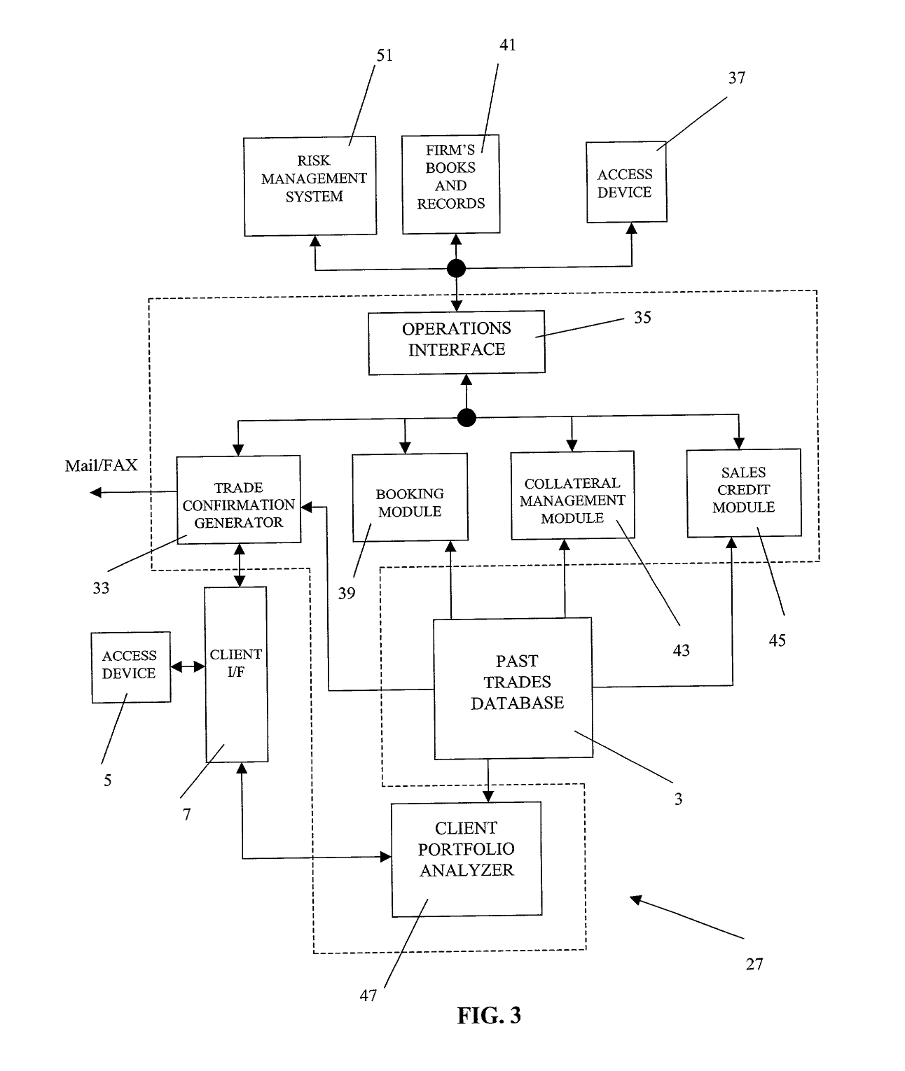

Once the OTC transaction is executed, a number of post-trade management functions are performed by post-trade management module 27. Referring now to FIG. 3, there is shown an expanded block diagram of post-trade management module 27. Elements of the embodiment of FIG. 3 that are similar to elements of the embodiment of FIG. 1 are similarly labeled and a detailed description thereof will not be repeated.

Post-trade management module 27 includes a trade confirmation generator 33 for automatically generating a trade confirmation that documents the OTC transaction. Trade confirmations evidence all of the economic and non-economic terms of the transaction and are required by Securities and Exchange Commission regulations. With respect to privately negotiated OTC transactions, a trade confirmation may include the specific economic terms as well as any special legal, credit and other non-economic terms that are applicable based upon the facts and circumstances of a particular transaction.

Once an OTC trade is executed and the terms of the trade are stored in past trades database 3, trade confirmation generator 33 receives from past trades database 3 the terms of the trade to be confirmed. Based on the trade terms, trade confirmation generator 33 automatically generates a trade confirmation according to an acceptable format such as, for example, the suggested formats published by the International Swaps and Derivatives Association, Inc. A system for generating trade confirmations based on the trade terms is disclosed in PCT Application No. PCT/US00/19331 entitled, “Object-Oriented Document Assembly System,” the contents of which are incorporated herein by reference.

The trade confirmation assembled by trade confirmation generator 33 is sent to the client using any number of methods including by mail and facsimile. In an exemplary embodiment, the trade confirmation is sent electronically to the client via client interface 7 using well-known techniques such as, by way of non-limiting example, by electronic mail or via an Internet browser. Because the trade confirmation serves a contractual agreement between the financial institution and the client that must be executed by the client, it is advantageous to the financial institution to present the trade confirmation to the client as soon as possible after trade execution. Thus, by sending the trade confirmation electronically, the client receives the trade confirmation immediately after a trade is executed. In an exemplary embodiment, the client receives and accepts the trade confirmation at the same time when the client accepts the trade.

Upon receipt of the trade confirmation, the client executes the trade confirmation and returns it to the financial institution via mail or facsimile. In an exemplary embodiment, the client executes the trade confirmation with, for example, an electronic signature, using well-known techniques, and then returns the executed trade confirmation electronically to trade confirmation generator 33 via client interface 7. The advantage in receiving the executed trade confirmation electronically from the client is that the financial institution can then shorten the period of time the client has to return the trade confirmation to the financial institution. If trade confirmation generator 33 does not receive the executed trade confirmation from the client within the given period of time, for example 48 hours, trade confirmation generator 33 notifies an operations manager, via an operations interface 35 and access device 37, that the trade confirmation was not received. If the trade confirmation was not received from the client, any appropriate action may be taken in response including, by way of non-limiting example, the unwinding of the trade.

Accordingly, systems 1,1 ′ provide the client with a trade confirmation automatically upon execution of the trade (or post-trade, as the client desires), thereby increasing the efficiency of, and reducing the overhead associated with, the trade documenting process.

Post-trade management module 27 also includes a booking module 39 that books the executed transactions to the firm's books and records 41 for performing a variety of post-trade bookkeeping functions including, by way of non-limiting example, accounting, collateral management, sales credit analysis, client revenue attribution and product settlement. Booking module 39 may also identify any trade having any characteristic for which the financial institution desires to have an operations manager check the validity and/or accuracy of such trade.

Market risk management system 51 reviews the trades stored in past trades database 3 and “nets” out the financial institution's exposure with respect to each underlying represented in such trades. After determining the financial institution's exposure in each underlying, market risk management system 51 reports such netting results to the firm's books and records 41 for inclusion therein. Also, market risk management system 51 monitors all trades currently on the books, by accessing past trades database 3, to notify the trader of any necessary hedging adjustments that should be made to the financial institution's position. Market risk management system 51 may also identify trades having unique trade parameters that require special handling such as, for example special trade expiration language, so that the operations manager or trader can respond accordingly.

Post-trade management module 27 also includes a collateral management module 43 for determining the collateral requirements of the clients as a result of the executed trades. Collateral management module 43 reviews all trades executed and posted in past trades database 3 and evaluates the credit exposure associated with such trades based on a variety of factors including, but not limited to, any changes in the market value of a client's positions and any changes in the client's credit status. Collateral management module 43 also accesses the firm's books and records 41 via operations interface 35 to determine the margin requirements attributed to each trade and the amount of collateral the client must post as a result. Based on the collateral requirements determined by collateral management module 43, the client's ability to make future trades may curtailed until additional collateral is posted. Thus, by automatically monitoring each client's collateral requirements with respect to all of each client's current positions, as reflected in past trades database 3, the financial institution's exposure to credit losses associated with holding a particular client's position is significantly reduced.

Also included in post-trade management module 27 is a sales credit module 45 that analyzes the executed trades posted in past trades database 3 to calculate client revenue attribution. Sales credit module 45 may calculate performance according to any criteria including, but not limited to, calculating the profits earned by the financial institution by transaction, client, salesperson and product. Such performance metrics are then reported to the firm's books and records 41 where they may be further evaluated. Thus, sales credit module 45 provides an analytic tool to measure the success of the financial institution's OTC business.

Post trade management module 27 also includes a client portfolio analyzer 47 for allowing a client to view, manage and analyze the client's portfolio. For example, to view past trades, a client accesses client portfolio analyzer 47, via client interface 7, that in turn retrieves from past trades database 3 the particular client's past trading activity for presenting such activity to the client in any suitable format. Client portfolio analyzer 47 also organizes the client's trading activity so that the client can more readily understand the client's position. For example, client portfolio analyzer 47 aggregates all similar transactions according to various criteria including, by way of non-limiting example, by derivative security and underlying asset, so that the client can easily determine the status of the client's position. For instance, if a client has executed a trading strategy consisting of a series of transactions, client portfolio analyzer 47 presents the series of transactions to the client as an aggregated or single position so that the client can easily determine the value of the position. Similarly, client portfolio analyzer 47 may present to a client the client's past trading activity, as reflected in past trades database 3, in any desired manner using well-known techniques.

In addition to viewing past trading activity, a client may also analyze the client's portfolio using any available financial analytic tools. In an exemplary embodiment, client interface 7 presents to the client a list of analytic tools that may be used to analyze the client's portfolio. Upon selecting a particular tool, client portfolio analyzer 47 retrieves from past trades database 3 any client trading information necessary for applying the selected analytic tool and presents to the client, via client interface 7, the results of the analysis. In another exemplary embodiment, client portfolio analyzer 47 has access to real-time economic and financial data that is required for implementing the analytic tools selected by the client. Thus, client portfolio analyzer 47 provides the client with a mechanism for viewing and analyzing the client's past trade activity in useful and selectable ways to help in the investment process.

In an exemplary embodiment, the client may initiate new trade requests based on the portfolio views presented to the client. For example, upon viewing a past trade in a particular security presented to the client by client portfolio analyzer 47 via client interface 7, the client may indicate to client interface 7, using well-known techniques such as, by way of non-limiting examples, mouse clicking or keyboard input, the client's desire to increment or decrement the client's position in the particular security. Client interface 7 then processes the client's request as a request to trade in the particular security using the techniques described above.

In summary, the system of the present invention provides a client an electronic connection, via the Internet or other suitable means, to a financial institution for transacting in OTC derivatives. The system includes an automated derivative market making function for electronically providing the client with real-time dealing prices including two-way (i.e., bid and offer) price quotes. By electronically accepting a provided dealing price, the client transacts in the particular OTC derivative and may also simultaneously accept an electronically created trade confirmation, all in real-time. In addition, the transaction is completed when the client accepts the dealing quote regardless of a trader's ability to hedge the particular transaction. The system also provides the client with a view of the client's existing and requested positions with all bid/offer pricing being continuously updated in real-time. Thus, the system of the present invention provides clients with real-time and transparent market data in the OTC derivatives markets.

Furthermore, in the system of the present invention, if a client is interested in a particular OTC derivative not currently in the client's portfolio, the client can post the requested derivative to an electronic bulletin board maintained by the system where a bid/offer market for the particular OTC derivative will be maintained and displayed to the client. Also, if a client has a question for a salesperson or trader regarding a particular product or transaction, a video and/or voice link is electronically provided for allowing the client to communicate with the salesperson or trader.

Accordingly, a system and method is provided in which clients of financial institutions are provided with real-time, dealing quotes for OTC securities. Furthermore, as pricing factors change, the system of the present invention continuously updates the quotes provided thereby providing the client with a virtual, real-time market in the particular OTC security. Based on the provided quotes, the client may transact in the security and receive confirmation of the transaction immediately. The system also provides the client with automated access to the client's trading activity for viewing, analyzing and updating the client's portfolio. The risk associated with providing clients with dealing quotes and trade executions is mitigated through automatically checking the client's ability to trade before issuing a price quote and by automatically hedging each trade request.

Based on the above description, one of ordinary skill may implement the system and methods of the present invention in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired, and in any case, the language may be a compiled or interpreted language Suitable processors include, by way of example, both general and special purpose microprocessors. Furthermore, alternate embodiments of the invention that implement the system in hardware, firmware or a combination of both hardware and software, as well as distributing modules and/or data in a different fashion will be apparent to those skilled in the art and are also within the scope of the invention. In addition, it will be obvious to one of ordinary skill to use a conventional database management system such as, by way of non-limiting example, Sybase, Oracle and DB2, as a platform for implementing the present invention.

It will thus be seen that the objects set forth above, among those made apparent from the preceding description, are efficiently attained and, because certain changes may be made in carrying out the above process in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

1. A system for facilitating a trade in a non-listed security, comprising:
a past trades database for storing trade information regarding past trades executed through the system;
a pricing engine for providing price quotes in the non-listed security, said pricing engine in communication with said past trades database, said pricing engine receiving as input financial information;
wherein when a client requests a price quote for the non-listed security, said pricing engine provides said price quote based on said past trades in said past trades database and said financial information.

2. The system of claim 1, further comprising a price log for storing said price quotes in the non-listed security, wherein said pricing engine provides said price quote based on said past quotes stored in said price log.

3. The system of claim 1, wherein said financial information includes interest rate information, dividend information relating to said non-listed security, tax credit information and borrowing cost information.

4. The system of claim 1, wherein said pricing engine receives surface volatility information and said pricing engine provides said price quote based on said surface volatility.

5. The system of claim 1, wherein said pricing engine receives pricing constraints and wherein said price quote provided by said pricing engine is based on said constraints.

6. The system of claim 1, wherein said pricing engine continuously updates said price quotes.

7. The system of claim 1, further comprising a check ability to trade (CATT) module wherein when said client desires to transact in the non-listed security, said CATT module determines the client's ability to trade.

8. The system of claim 7, wherein said CATT module determines the client's ability to trade based on the client's credit status.

9. The system of claim 1, wherein the client issues a request to trade said non-listed security based on said price quote.

10. The system of claim 9, wherein the client issues said request to trade electronically.

11. The system of claim 9, further comprising a hedging module for performing hedging transactions, wherein when said client requests a trade in the non-listed security, said hedging module executes a hedging transaction for hedging said trade.

12. The system of claim 11, wherein information regarding said trade is stored in said past trades database.

13. The system of claim 12, further comprising a trade confirmation generator in communication with said past trades database, wherein when said trade is stored in said past trades database, said trade confirmation generator generates a trade confirmation based on said trade information and said trade confirmation is provided to said client.

14. The system of claim 13, wherein said trade confirmation is provided to said client electronically.

15. The system of claim 14, wherein said client requests a trade and accepts said trade confirmation simultaneously.

16. The system of claim 12, further comprising a risk management system, said risk management system in communication with said past trades database for determining a net position for each non-listed security in said past trades database.

17. The system of claim 12, further comprising a booking module for forwarding said trade information to a firm's books and records.

18. The system of claim 16, wherein some of said trades in said past trades database require special handling and said risk management system identifies some of said trades in said past trades database that require special handling.

19. The system of claim 12, further comprising a collateral management module, said collateral management module in communication with said past trades database for determining the client's collateral requirements.

20. The system of claim 12, further comprising a sales credit module, said sales credit module in communication with said past trades database for calculating a performance measure of said trades.

21. The system of claim 20, wherein said performance measure is profits per each client.

22. The system of claim 20, wherein said performance measure is profits per each security.

23. The system of claim 20, wherein said performance measure is per each sales representative of said financial institution.

24. The system of claim 12, further comprising a client portfolio analyzer, said client portfolio analyzer in communication with said past trades database for providing said client with viewing access of said trades performed by said client.

25. The system of claim 24, wherein said client portfolio analyzer aggregates at least some of said trades performed by said client by security.

26. The system of claim 24, wherein said client portfolio analyzer aggregates at least some of said trades performed by said client by strategy.

27. The system of claim 24, wherein said client portfolio analyzer performs an analysis of at least some of said trades and forwards a result of said analysis to said client.

28. The system of claim 1, wherein at least one of said price quotes includes a bid price and an offer price.

29. A system for forming a market in a non-listed security for facilitating trades in the non-listed security, comprising:
a past trades database for storing trade information regarding past trades executed through the system;
an automatic market making engine for providing price quotes in the non-listed security to a client, said automatic market making engine being in communication with said past trades database and receiving financial information as input, said automatic market making engine continuously updating said price quotes based on changes to said financial information;
a hedging module for performing hedging transactions;
wherein when said client requests a trade in said non-listed security based on said price provided by said automatic market making engine, said hedging module executes a hedging transaction for hedging said trade and said trade is stored in said past trades database.

30. The system of claim 29, further comprising a check ability to trade (CATT) module wherein when said client desires to transact in the non-listed security, said CATT module determines the client's ability to trade.

31. The system of claim 30, wherein said CATT module determines the client's ability to trade based on the client's credit status.

32. The system of claim 29, further comprising a trade confirmation generator in communication with said past trades database, wherein when said trade is stored in said past trades database, said trade confirmation generator generates a trade confirmation based on said trade information and said trade confirmation is provided to said client.

33. The system of claim 32, wherein said trade confirmation is provided to said client electronically.

34. The system of claim 33, wherein said client requests a trade and accepts said trade confirmation simultaneously.

35. The system of claim 29, further comprising a risk management system, said risk management system in communication with said past trades database for determining a net position for each non-listed security in said past trades database.

36. The system of claim 29, further comprising a booking module for forwarding said trade information to a firm's books and records.

37. The system of claim 35, wherein some of said trades in said past trades database require special handling and said risk management system identifies some of said trades in said past trades database that require special handling.

38. The system of claim 29, further comprising a collateral management module, said collateral management module in communication with said past trades database for determining the client's collateral requirements.

39. The system of claim 29, further comprising a sales credit module, said sales credit module in communication with said past trades database for calculating a performance measure of said trades.

40. The system of claim 39, wherein said performance measure is profits earned by the financial institution per each client.

41. The system of claim 39, wherein said performance measure is profits earned by the financial institution per each security.

42. The system of claim 39, wherein said performance measure is profits earned by the financial institution per each sales representative of said financial institution.

43. The system of claim 29, further comprising a client portfolio analyzer, said client portfolio analyzer in communication with said past trades database for providing said client with viewing access of said trades performed by said client.

44. The system of claim 43, wherein said client portfolio analyzer aggregates at least some of said trades performed by said client by security.

45. The system of claim 43, wherein said client portfolio analyzer aggregates at least some of said trades performed by said client by strategy.

46. The system of claim 43, wherein said client portfolio analyzer performs an analysis of at least some of said trades and forwards a result of said analysis to said client.

47. The system of claim 29, wherein at least one of said price quotes includes a bid price and an offer price.

48. A method for facilitating trades in a non-listed security, comprising the steps of:
forming a past trades database from past trade information;
obtaining from a data source real-time economic and financial data;
providing a price quote in said non-listed security based on said real-time economic and financial data and on said past trade information contained in said past trades database;
receiving a request to trade in said non-listed security based on said price quote;
performing a hedging transaction for hedging said trade; and
storing information of said trade in said past trades database.

49. The method of claim 48, further comprising the step of:
continuously updating said price quotes.

50. The method of claim 48, further comprising the step of:
submitting electronically a request to trade based on said price quotes.

51. The method of claim 48, further comprising the step of:
determining the client's ability to trade.

52. The method of claim 51, wherein the step of determining the client's ability to trade includes the step of:
determining the client's ability to trade based on the client's credit status.

53. The method of claim 48, further comprising the steps of:
generating a trade confirmation based on said trade information; and
providing said trade confirmation to said client.

54. The method of claim 53, wherein the step of providing said trade confirmation includes the step of:
providing said trade confirmation electronically.

55. The method of claim 54, wherein said step of receiving a request to trade includes the step of: simultaneously accepting said trade confirmation.

56. The method of claim 48, further comprising the step of:
determining a net position for each non-listed security in said past trades database.

57. The method of claim 48, further comprising the step of:
forwarding said trade information to a firm's books and records.

58. The method of claim 48, further comprising the step of:
identifying those of said trades in said past trades database that require special handling.

59. The method of claim 48, further comprising the step of:
determining the client's collateral requirements.

60. The method of claim 48, further comprising the step of:
calculating a performance measure of said trades in said past trades database.

61. The method of claim 60, wherein said performance measure is profits earned by the financial institution per each client.

62. The method of claim 60, wherein said performance measure is profits earned by the financial institution per each security.

63. The method of claim 60, wherein said performance measure is profits earned by the financial institution per each sales representative of said financial institution.

64. The method of claim 48, further comprising the step of:
providing said client with viewing access of said trades performed by said client.

65. The method of claim 48, further comprising the step of:
aggregating at least some of said trades performed by said client by security.

66. The method of claim 48, further comprising the step of:
aggregating at least some of said trades performed by said client by strategy.

67. The method of claim 48, further comprising the steps of:
performing an analysis of at least some of said trades in said past trades database; and forwarding a result of said analysis to said client.

68. The method of claim 48, wherein said price quote includes a bid price and an offer price.

69. A method for forming a market in a non-listed security, comprising the steps of:
receiving a price request for said non-listed security;
automatically generating a price quote in said non-listed security based on financial information;
presenting said price quote in response to said price request; and
continuously updating said price quotes based on changes to said financial information.

70. The method of claim 69, further comprising the steps of:
forming a past trades database from past trade information;
obtaining from a data source real-time economic and financial data; and wherein said step of automatically generating a price quote includes the step of:
automatically generating a price quote in said non-listed security based on said real-time economic and financial data and on said past trade information contained in said past trade database;

71. The method of claim 70, further including the steps of:
receiving a request to trade in said non-listed security based on said price quote;
performing a hedging transaction for hedging said trade; and
storing information of said trade in said past trades database.

72. The method of claim 69, wherein said price quote includes a bid price and an offer price.
